(19) United States
(12) Patent Application Publication
(10) Pub. No.: US 2024/0383785 A1
(43) Pub. Date: Nov. 21, 2024

(54) METHOD OF WASTEWATER TREATMENT

(71) Applicant: NATIONAL TAIWAN UNIVERSITY, Taipei City (TW)

(72) Inventors: Chihhao FAN, Taipei City (TW); You-Yi LEE, Taipei City (TW)

(73) Assignee: NATIONAL TAIWAN UNIVERSITY, Taipei City (TW)

(21) Appl. No.: 18/524,864

(22) Filed: Nov. 30, 2023

(30) Foreign Application Priority Data
May 15, 2023 (TW) 112117933

(51) Int. Cl. C02F 1/72; C02F 3/12

(52) U.S. Cl. CPC C02F 1/722; C02F 1/725; C02F 3/1263; C02F 2101/38; C02F 2305/026

(57) ABSTRACT

The present disclosure relates to a method of wastewater treatment, including an advanced oxidation process, pretreating wastewater to oxidize organic pollutants in the wastewater, and a biodegradation process, treating the pretreated wastewater to remove the oxidized organic pollutants, wherein the organic pollutants are unsaturated compounds containing electron-withdrawing functional group, such as carbamazepine.

### CROSS-REFERENCE TO RELATED APPLICATIONS

This application claims priority to Taiwan Application Serial No. 112117933,filed on May 15, 2023. The entirety of the above-mentioned patent application is hereby incorporated by reference herein and made a part of this specification.

### BACKGROUND

### Technical Field

The present disclosure relates to a method of wastewater treatment, and particularly to a method of wastewater treatment combining an advanced oxidation process (AOP) pretreatment followed by a biodegradation process.

### Description of Relevant Art

Contaminants of emerging concern have become one of the major environmental concerns. They are usually characterized by being difficult to decompose in the environment, leading to common occurrence of detection in various water systems including drinking water, thus attracting enormous attention from the public. Drugs are an important category in contaminants of emerging concern, most crucially due to its significant bioactivity. Wastewater treatment plant and water purification plant typically treat previously common contaminants, and cannot adequately remove contaminants of emerging concern. This situation thereby makes it possible for wastes containing active drug substances to enter drinking water systems and food chains, posing adverse effect on aquatic lifeform and human health, even affecting human health.

Carbamazepine (CBZ) is an extensively utilized drug and has become one of the most commonly detected contaminants of emerging concern in various water bodies because CBZ is difficult to decompose by wastewater treatment plants. That CBZ is characterized by being difficult to decompose is due to the fact that CBZ is an unsaturated compound containing a strong electron-withdrawing amide functional group, making it difficult to remove through conventional wastewater treatment processes. In most wastewater treatment plants, the removal rate of CBZ is 10% or less (Zhang, Yongjun, et al. “Carbamazepine and Diclofenac: Removal in Wastewater Treatment Plants and Occurrence in Water Bodies.” Chemosphere, vol. 73, no. 8, 2008, pp. 1151-1161). Therefore, CBZ is considered to be one of the indicators of artificial wastewater pollution. Currently, there are few methods that can effectively remove CBZ and be practically applied in wastewater treatment plants.

Methods for physical removal of organics from wastewater include the use of activated carbon or membrane filters. However, these methods cannot be deployed in wastewater treatment plants at scale because of high operation costs derived from various issues such as maintenance of filtration system efficiency and renewal or replacement of adsorbent or filter membrane. Currently, wastewater treatment plants mostly deploy biodegradation processes such as activated sludge treatment to remove organics from wastewater. However, it is difficult for these treatment methods to decompose compounds containing a strong electron-withdrawing functional group, such as CBZ, and the compounds are even toxic to the microbes within the activated sludge.

Accordingly, the field of wastewater treatment urgently needs a low-cost, easy-to-operate wastewater treatment method that can be deployed in wastewater treatment plants at scale to remove various contaminants of emerging concern.

### SUMMARY

The present disclosure relates to a method of wastewater treatment, comprising an advanced oxidation process, pretreating wastewater to oxidize organic pollutants in the wastewater: and a biodegradation process, treating the pretreated wastewater to remove the oxidized organic pollutants, wherein the organic pollutants are unsaturated compounds containing a strong electron-withdrawing functional group.

In one embodiment of the present disclosure, the advanced oxidation process is Fenton oxidation, which comprises oxidizing the organic pollutants with hydrogen peroxide as an oxidant under the catalysis of ferrous ions; and the biodegradation process is activated sludge treatment.

In one embodiment of the present disclosure, a molar ratio of the hydrogen peroxide to the ferrous ion is 0.5:1 to 50:1.

In one embodiment of the present disclosure, concentrations of the hydrogen peroxide and the ferrous ion are 50 μM to 10000 μM.

In one embodiment of the present disclosure, the Fenton oxidation is carried out under a condition of an initial pH of the wastewater being 3 to 7.

In one embodiment of the present disclosure, the biodegradation process is carried out with a sequencing batch reactor, and each batch comprises four stages: inflow, aeration, sedimentation, and outflow.

In one embodiment of the present disclosure, the unsaturated compounds containing a strong electron-withdrawing functional group are cyclic unsaturated compounds containing an amide: Ar—C(═O)—NR1R2, wherein Ar represents a substituted or unsubstituted aryl or heteroaryl, R1 and R2 are each independently hydrogen, a substituted or unsubstituted alkyl or alkyl containing a heteroatom.

In one embodiment of the present disclosure, the cyclic unsaturated compounds containing an amide comprise at least one selected from the group consisting of carbamazepine, N-substituted carbamazepine, oxcarbazepine, N-substituted oxcarbazepine, benzamide, and N-substituted benzamide.

In one embodiment of the present disclosure, a degradation rate of the unsaturated compounds containing a strong electron-withdrawing functional group is 75% or above after treating the pretreated wastewater by the biodegradation process.

In one embodiment of the present disclosure, a mineralization rate of the unsaturated compounds containing a strong electron-withdrawing functional group is 8% or above after treating the pretreated wastewater by the biodegradation process.

Through combining advanced oxidation process pretreatment and a biodegradation process in series, the present disclosure effectively removes unsaturated compounds containing a strong electron-withdrawing functional group, achieving advantages of low cost, easy access to materials, convenient process and operation. The present disclosure can practically be deployed in wastewater treatment plants.

### BRIEF DESCRIPTION OF THE DRAWINGS

FIG. 1 is a flow chart of the wastewater treatment method of the present disclosure.

FIGS. 2A and 2B are respectively a degradation rate graph and a

mineralization rate graph of CBZ under a combined Fenton oxidation pretreatment and activated sludge treatment in series.

FIGS. 3A-3L are an excitation-emission matrix of CBZ under a combined Fenton oxidation pretreatment and activated sludge treatment in series.

### DETAILED DESCRIPTION

The implementations illustrated in the embodiments of the present disclosure will be described more clearly and completely below. Obviously, the described embodiments are only a set of the various embodiments covered by the present disclosure and are not intended to limit the scope of the present disclosure. The present disclosure can be practiced or applied by other alternative embodiments. Other embodiments obtained by those skilled in the art without creation, such as modification, change or replacement of a certain element or combination thereof, are included within the scope of the present disclosure.

It should be further noted, the singular forms “a” and “the” used herein are intended to include plural referents unless they are otherwise specifically limited to a single referent. In addition, unless otherwise specifically indicated, the term “or” and “and/or” used herein are interchangeable.

The term “about” used in the present disclosure refers to an error or a range of a numerical value, a numerical range or a ratio is within 20% of the numerical value, the numerical range or the ratio, preferably within 10%, more preferably to fluctuate within 5%. The quantitative values used herein are approximations, meaning that they can be inferred even when the term “about” is not used. The numerical ranges used herein covers all numerical values that fall within the numerical range, for example, a numerical range 3 to 7 covers numerical values of 3, 3.01, 3.1, 3.5 and the likes, and also covers all sub-ranges that fall within the numerical range, wherein the sub-ranges are bordered by each number that falls within the numerical range, for example, a numerical range of 3 to 7 encompasses subranges of 3 to 6, 4 to 7, 4 to 6 and the likes.

The term “comprise/comprising,” “include/including,” “contain/containing” or “have/having” used herein refers to some elements such as components, steps and the likes that exist in a product, a method, use and the like of the present disclosure.

Unless specifically indicated in the context otherwise, those undocumented and unspecified elements are also open to exist in a product, a method or use of the present disclosure, whether it is necessary or not. In other word, those undocumented and unspecified elements are not restrictively excluded.

The present disclosure relates to a method of wastewater treatment, comprising an advanced oxidation process, pretreating wastewater to oxidize organic pollutants in the wastewater; and a biodegradation process, treating the pretreated wastewater to remove the oxidized organic pollutants, wherein the organic pollutants are unsaturated compounds containing a strong electron-withdrawing functional group.

The phrase “advanced oxidation process” used herein refers to a chemical reaction where a chemical agent produces a strong oxidant, usually a hydroxyl radical, to effectively decomposes pollutants in wastewater. For example, an advanced oxidation process that oxidizes organics in wastewater may be photochemical oxidation, catalytic wet oxidation, sonochemical oxidation, ozone oxidation, electrochemical oxidation, Fenton oxidation, or Fenton-like oxidation. In one embodiment of the present disclosure, the advanced oxidation process is Fenton oxidation, which oxidizes the organic pollutants with hydrogen peroxide as an oxidant under catalysis of ferrous [iron (II)] ions, wherein the hydrogen peroxide reacts with the ferrous ions to generate hydroxyl radicals and iron (III) ions, then the iron (III) ions react with another hydrogen peroxide to generate hydroperoxyl radicals and iron (II) ions, and thereby the iron (II) ions can react with the next hydrogen peroxide. The Fenton oxidation described in the present disclosure includes traditional Fenton oxidation and treatment methods derived from Fenton oxidation known to those skilled in the art.

The phrase “biodegradation process” used herein refers to a biological metabolism process where microbes decompose pollutants in wastewater. In one embodiment of the present disclosure, the biodegradation process is activated sludge treatment. The phrase “activated sludge treatment” used herein refers to wastewater treatment methods where an activated sludge, usually consisting of aerobic bacteria, breaks down organics within the wastewater.

In one embodiment of the present disclosure, the molar ratio of the hydrogen peroxide to the ferrous ion is 0.5:1 to 50:1. In another embodiment of the present disclosure, the molar ratio of the hydrogen peroxide to the ferrous ion is 1:1. In yet another embodiment of the present disclosure, the molar ratio of the hydrogen peroxide to the ferrous ion is 2:1. In other embodiments, the molar ratio of the hydrogen peroxide to the ferrous ion is about 0.5:1, about 1:1, about 2:1, about 5:1, about 10:1, about 20:1 or about 50:1.

In one embodiment of the present disclosure, the concentrations of the hydrogen peroxide and the ferrous ion are each independently 50 μM to 10000 μM. In one embodiment of the present disclosure, the concentration of the hydrogen peroxide is 100 μM. In another embodiment of the present disclosure, the concentration of the hydrogen peroxide is 200 μM. In yet another embodiment of the present disclosure, the concentration of the hydrogen peroxide is 3000 μM. In other embodiments of the present disclosure, the concentration of the hydrogen peroxide is about 50 μM, about 100 μM, about 500 μM, about 1000 μM, about 2000 μM, about 3000 μM, about 4000 μM, about 5000 μM or about 10000 μM. In one embodiment of the present disclosure, the concentration of the ferrous ion is 100 μM. In another embodiment of the present disclosure, the concentration of the ferrous ion is 200 μM. In yet another embodiment of the present disclosure, the concentration of the ferrous ion is 3000 μM. In other embodiments of the present disclosure, the concentration of the ferrous ion is about 50 μM, about 100 μM, about 500 μM, about 1000 μM, about 2000 μM, about 3000 μM, about 4000 μM, about 5000 μM or about 10000 μM.

In one embodiment of the present disclosure, the Fenton oxidation may be carried out under an acidic environment or a neutral environment, and upon consideration of operability and environmental friendliness, the Fenton oxidation may be carried out under neutral environment. In one embodiment of the present disclosure, when wastewater is pretreated by an advanced oxidation process such as Fenton oxidation, the initial pH of the wastewater is about 3 to about 7. In another embodiment of the present disclosure, when wastewater is pretreated by Fenton oxidation, the initial pH of the wastewater is about 3. In yet another embodiment of the present disclosure, Fenton oxidation is carried out under the condition of the initial pH of wastewater being about 7. In other embodiments of the present disclosure,

Fenton oxidation is carried out under the condition of the initial pH of wastewater being about 3, about 4, about 5, about 6 or about 7.

In one embodiment of the present disclosure, the biodegradation process is carried out with a sequencing batch reactor, and each batch comprises four stages:

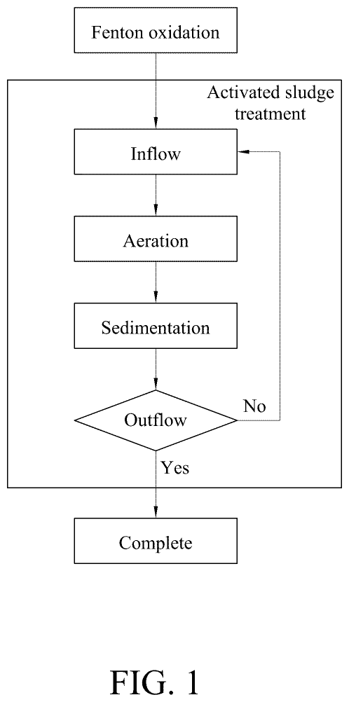

inflow, aeration, sedimentation and outflow. FIG. 1 is a flow chart of one embodiment of the wastewater treatment method of the present disclosure, advanced oxidation process pretreatment (for example, Fenton oxidation) is followed by a biodegradation process (for example, activated sludge treatment). In the embodiment of FIG. 1, activated sludge treatment can be carried out with a sequencing batch reactor. Below, wastewater is exemplified using a CBZ-containing solution. Specifically, in the wastewater treatment method of the present disclosure, wastewater to be treated may be first fed into a chemical reactor, and then Fenton reagents (e.g. hydrogen peroxides and ferrous ions) are added to carry out the Fenton reaction. In practical applications, the chemical reactor may be exemplified as a coagulation and sedimentation tank, and Fenton reagents may be added together with coagulants into the coagulation and sedimentation tank. Afterward, entering into the biodegradation process, where the wastewater in the chemical reactor (or a buffer tank connecting to the chemical reactor) is transported to a batch reactor containing an activated sludge in the inflow stage; in the aeration stage, a gas such as air is introduced into the batch reactor through an air pump and dispersed throughout the wastewater through a disc diffuser, and the activated sludge fully reacts with the wastewater under a continuous stirring condition:

in the sedimentation stage, stirring is stopped: and in the outflow stage, the unsettled liquid component or supernatant in the sedimentation stage is exported, for example, to a storage tank, or it may be recycled and back into the chemical reactor to carry out the biodegradation process again.

In one embodiment of the present disclosure, Fenton oxidation may last for

10 minutes to 2 hours, for example 10 minutes, 15 minutes, 20 minutes, 30 minutes, 40 minutes, 45 minutes, 50 minutes, 1 hour, 1.5 hours or 2 hours. In another embodiment of the present disclosure, each batch of a biodegradation process may last for 2 to 8 hours, for example 2, 3, 4, 5, 6, 7, or 8 hours. In yet another embodiment of the present disclosure, an inflow stage may last for 10 to 30 minutes, an aeration stage may last for 1.5 to 7 hours, a sedimentation stage may last for 5 to 30 minutes, and an outflow stage may last for 5 to 30 minutes.

In one embodiment of the present disclosure, the unsaturated compounds containing a strong electron-withdrawing functional group are cyclic unsaturated compounds containing an amide: Ar—C(═O)—NR1R2, wherein Ar represents a substituted or unsubstituted aryl or heteroaryl, R1 and R2 are each independently hydrogen, a substituted or unsubstituted alkyl or alkyl containing a heteroatom.

Herein, “aryl” refers to for example C6 to C30 aryl group, and “heteroaryl” refers to for example C6 to C30 aryl group with aromatic ring carbon being replaced by heteroatoms N, O, S, etc. Herein, “alkyl” refers to for example C1 to C20 alkyl group, and “alkyl containing a heteroatom” refers to for example Cl to C20 alkyl group with chain carbon being replaced by at least one heteroatom N, O, S, etc. Aryl, heteroaryl, alkyl and alkyl containing a heteroatom can all be substituted with a substituent such as an alkyl, an aryl, a heteroaryl, ═O, an acyl, an alkoxy, an amino, a hydroxyl, a halo, etc.

In one embodiment of the present disclosure, the cyclic unsaturated

compounds containing an amide comprise at least one of the group consisting of carbamazepine, N-substituted carbamazepine, oxcarbazepine, N-substituted oxcarbazepine, benzamide, and N-substituted benzamide. The N-substituted compound refers to hydrogen on a nitrogen atom being substituted with a substituent such as an alkyl, an aryl, a heteroaryl, ═O, an acyl, an alkoxy, an amino, a hydroxyl, a halo. In one embodiment of the present disclosure, the N-substituent is an alkyl.

In one embodiment of the present disclosure, the degradation rate of the compounds containing a strong electron-withdrawing functional group is 75% or above, 80% or above, or 83% or above after treating the pretreated wastewater by the biodegradation process. In one embodiment of the present disclosure, the degradation rate of the compounds containing a strong electron-withdrawing functional group is about 75%, about 80%, about 83%, about 85%, about 90%, about 95%, about 99%, or about 100%.

In one embodiment of the present disclosure, the mineralization rate of the compounds containing a strong electron-withdrawing functional group is 8% or above, or 9% or above after treating the pretreated wastewater by the biodegradation process. In one embodiment of the present disclosure, the mineralization rate of the compounds containing a strong electron-withdrawing functional group is about 8%, about 9%, about 10%, about 15%, about 20%, about 25%, about 30%, about 35%, about 45%, about 55%, about 65%, or about 70%.

The phrase “strong electron-withdrawing functional group” used herein refers to a group in a molecule that, due to its stronger polarity (electronegativity), shifts the bond electron cloud towards it (i.e., the group with stronger polarity (electronegativity)). In the case of an aromatic compound having an immediately adjacent strong electron-withdrawing functional group, the strong electron-withdrawing functional group has the characteristic of strongly withdrawing the electron cloud in the unsaturated aromatic benzene ring structure, passivating the reactivity of the aromatic benzene ring for electrophilic substitution.

The term “degradation” used herein refers to a reaction that changes the structure of a specific compound, including a decrease in the number of carbon atoms in the molecule and a decrease in molecular weight, resulting in a product that is not the original compound anymore. However, there may still be secondary products that are not fully mineralized. The term “mineralization” used herein refers to a reaction that breaks down a specific compound into carbon dioxide and water.

The present disclosure is further illustrated in detail through the following specific Examples, but the scope of the present disclosure is by no means limited thereto.

### EXAMPLES

Chemicals and Preparation Method

Carbamazepine (CBZ: purchased from Sigma-Aldrich) and other chemicals used in this study were all at least Reagent Grade. Chemicals used in HPLC were

HPLC analysis grade.

CBZ solution was prepared weekly. Weigh 94.5 mg of CBZ powder and dissolve it in 1L deionized water to prepare a 400 μM CBZ stock solution.

In acidic Fenton oxidation, reagents were prepared weekly and stored in a 4° C. fridge. A 1M ferrous sulfate heptahydrate (FeSO₄·7H₂O; India, Avantor) stock solution was prepared and acidity was adjusted with sulfuric acid to about pH=2. A purchased 3 wt % sodium hydroxide solution (Germany, Sigma-Aldrich) was diluted to prepare a 0.5M sodium hydroxide stock solution and was stored in a brown bottle to prevent photodegradation. A 200 mM sodium thiosulfate (Na₂S₂O₃; UK, Alfa Aesar) stock solution was prepared as a quenching reagent. Each of the stock solutions described above can be further diluted into various concentrations as needed for each experiment.

Synthetic wastewater included COD, nitrogen and phosphorus at a fixed ratio of 100:5:1 to maintain microbial activity in the sequencing batch reactor. Main source of carbon, nitrogen and phosphorus were CH₃COONa·3H₂O (300 mg/L COD: USA, Avantor), NH₄Cl (15 mg/L: Japan, Nacalai Tesque) and KH₂PO₄ (3 mg/L: China,

Sigma-Aldrich), respectively. CaCl₂·2H₂O (9.2 mg/L; Japan, Nihon Shiyaku), MgSO₄·7H₂O (25.6 mg/L: Japan, Shimakyu) and a nutrient solution (25 μL/L) were also used to prepare the synthetic wastewater. Each liter of the nutrient solution consisted of the following compounds: 9 g of FeCl₃ (Japan, Nihon Shiyaku), 1.5 g of H₃BO₃ (USA, Honeywell), 1.3 g of CuSO₄·5H₂O (Germany, Honeywell), 1.8 g of KI (Germany, Merck), 0.6 g of MnCl₂·4H₂O (Japan, Hayashi), 4.2 g of Na₂MoO₄·2H₂O (Japan, Nihon Shiyaku), 1.2 g of ZnSO₄·7H₂O (Japan, Nihon Shiyaku), 0.6 g of CoCl₂·6H₂O (Japan, Ishizu) and 1 g of EDTA (Japan, Nacalai Tesque).

Analysis Method

Acidity Value and Oxidation-Reduction Potential Measurement

Acidity value (pH) and oxidation-reduction potential (ORP) were both measured with electrodes. Before measurement, a pH meter (HOTEX INSTRUMENTS, Taiwan) was calibrated with a pH standard solution having pH 4.01/7.00/10.01, and a ORP meter (HOTEX INSTRUMENTS, Taiwan) was calibrated with a ORP standard solution at 220 mV.

HPLC Analysis

The concentration of CBZ was quantified using Thermo Scientific Ultimate 3000 HPLC with an Agilent HC—C18(2) 250×4.6 mm 5 μm column and a UV detector. Mobile phase was methanol:water=60%: 40%; column temperature was 30° C.: flow rate was 0.6 mL/min; injection volume was 50 μL: the wavelength of the UV detector was 286 nm: the total retention time was 15 minutes: CBZ peak retention time was 13.5 minutes.

TOC Analysis

Total organic carbon (TOC) was monitored using verified heated persulfate wet oxidation with OIA 1030W TOC analysis instrument to monitor the level of organic pollutants in the liquid sample. The detection method required reagents of 10% sodium persulfate and 5% phosphoric acid. In the detection method of this experiment, sample volume was 2 mL: O₂ pressure was 22 psi: Na₂S₂O₈ volume was 2 mL; H₃PO₄ volume was 1 mL; TIC reaction time was 1.5 minutes: TIC detection time was 3 minutes: TOC reaction time was 3 minutes: and TOC detection time was 5minutes.

Fluorescence Spectroscopy Analysis

Perkin Elmer LS-15 fluorescence spectrometer with data processing FL WINLAB software was used to obtain excitation-emission matrix (EEM). The system included a xenon arc lamp as a radiation source. The excitation and emission slit was set at 10 nm. Record EEM in the wavelength range of λem=250-600 nm and λ ex=200-500 nm with the step width (of both)=5 nm. In 3D emission scan mode, scanning speed was 500 nm/min.

Fenton Oxidation

In the Fenton oxidation experiment, CBZ was diluted to a starting concentration of 50 μM from the CBZ stock solution. The acidic FeSO₄ stock solution was added to a 1000 mL CBZ solution to reach specific experimental conditions. Before the reaction, the pH was adjusted (for example, using sodium hydroxide) first to ensure that Fenton oxidation was carried out under a condition of an acidic (pH=about 3) or a neutral (pH=about 7) starting environment. The solution was continuously stirred at 500 rpm during the reaction. After adding a given concentration of hydrogen peroxide into the solution, the reaction started.

Activated Sludge Treatment

In a series combination of Fenton oxidation and activated sludge treatment, the device used had two reaction tanks, one reaction tank was a chemical reactor for the aforementioned mentioned Fenton reaction, and the other reaction tank was a sequencing batch reactor (SBR) for the activated sludge treatment. The SBR had a working volume of 4 L and was equipped with an aquarium-type air pump and a disc diffuser at the bottom of the reactor for aeration. Magnetic stirrers were set up at the four corners of the reactor to completely mix the activated sludge during aeration. A peristaltic pump (Kingtech Scientific, Taiwan) was used to automatically input the influent and output the effluent (both were 1 L) cyclically. The reactor was operated sequentially with a cycle time of 4 hours, including inflow (15 min), aeration (210min), sedimentation (10 min), and outflow (5 min). All of the stages were carried out automatically and continuously by a time switch. The initial activated sludge was taken from the wastewater treatment plant in Tucheng Industrial Park, and was acclimated in the laboratory with synthetic wastewater for one month.

Samples were collected at the beginning and 1, 2, 3 and 4 hours after the reaction started. Samples were filtered through a 0.22 um filter and analyzed by HPLC, TOC and EEM.

Example 1: Combining a Fenton Oxidation and an Activated Sludge Treatment to Degrade and Mineralize CBZ

In the past, it is difficult to fully mineralize CBZ using either Fenton oxidation or an activated sludge treatment process. The present disclosure surprisingly discovered that CBZ pretreated with Fenton oxidation followed by an activated sludge treatment exhibits a complete CBZ removal effect.

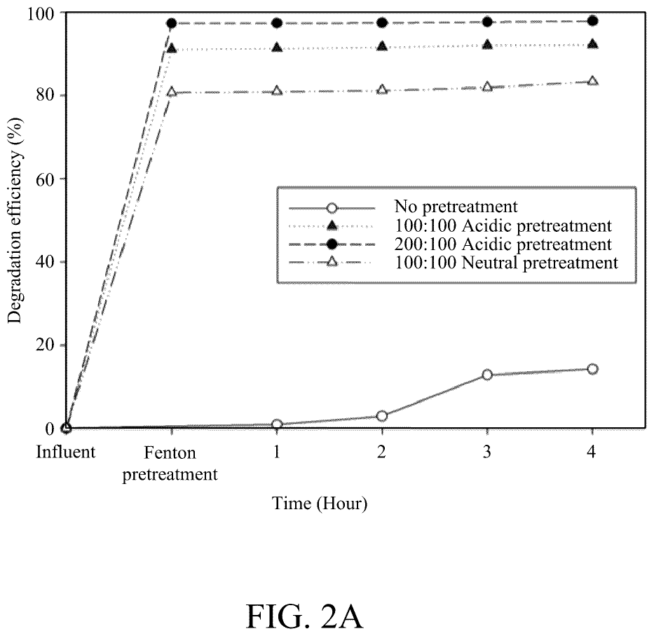

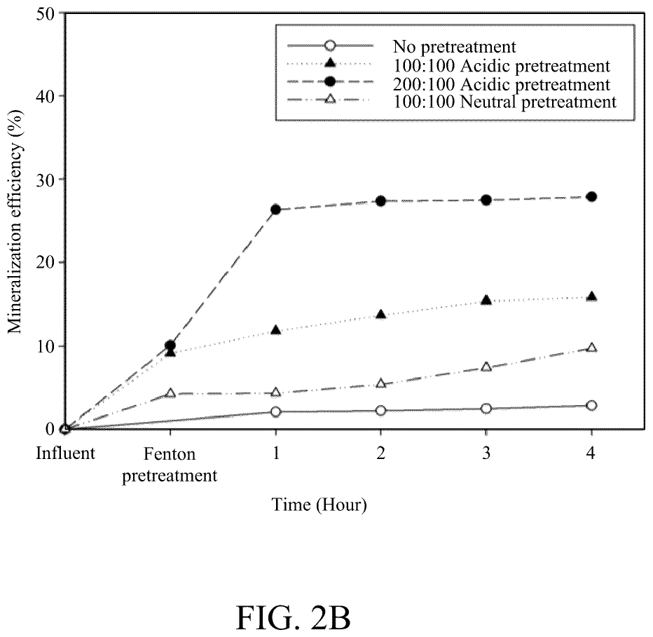

The results of different pretreatment conditions were summarized in Table 1 and FIGS. 2A and 2B. The activated sludge treatment was carried out through the sequencing batch mode with a 4-hour treatment cycle. The biodegradation of CBZ was evaluated by a standalone CBZ removal experiment without Fenton oxidation pretreatment. The results showed that its degradation rate and mineralization rate were about 14.21% and 2.86%, respectively. The low degradation rate indicated that the standalone treatment was less effective in CBZ removal from wastewater, and the physical and chemical properties of CBZ may be the factors that affect the removal efficiency of the activated sludge. It has been reported that CBZ is relatively hydrophobic, and its removal rate by sorption onto activated sludge falls within a range between 5 to 20% only. In addition, CBZ molecular structure contains amide, which is a strong electron-withdrawing functional group that makes CBZ resistant to biodegradation. Therefore, it can be assumed that the removal of CBZ by activated sludge is mostly via sludge sorption rather than actual biodegradation, and such removal is poor and unstable.

Fenton oxidation was operated as pretreatment to decompose CBZ before biodegradation. After the Fenton oxidation pretreatment, oxidation was quenched and the pH value was adjusted to about 7 to ensure microbial activity within the sludge. After pretreatment under different Fenton oxidation conditions, different CBZ residues were produced. To prevent dilution by the influent causing misunderstanding of the degradation rate and mineralization rate as wastewater is introduced into SBR, the removal efficiencies were calculated by the total weight of CBZ and TOC remained in the solution. The degradation rate and mineralization rate showed that the activated sludge treatment is able to further decompose the remaining CBZ and its oxidized byproducts after Fenton oxidation pretreatment (FIG. 2A and 2B). The pretreatment with 200 uM HO₂O₂ and 100 uM Fe²⁺ under an acidic condition showed the highest relative degradation rate and mineralization rate of 97.90% and 28.87% (FIG. 2B), respectively, indicating that the oxidized byproducts of CBZ are more readily biodegradable than the parent CBZ compound.

Through Fenton oxidation pretreatment, CBZ is oxidized and decomposed into CBZ oxidized byproducts, resulting in deterioration of the ability of CBZ to inhibit the microbial degradation of activated sludge. Thus, activated sludge no longer relies solely on sorption to remove pollutants such as CBZ, but can greatly increase 10 the removal rate through biodegradation.

TABLE 1

| | Influent | | | Fenton oxidation pretreatment | | | After 4 hours of activated sludge treatment | | | |
|---|---|---|---|---|---|---|---|---|---|---|
| Pretreatment | CBZ | TOC | CBZ | Degradation | TOC | Mineralization | CBZ | Degradation | TOC | Mineralization |
| condition | (mg) | (mg) | (mg) | (%) | (mg) | (%) | (mg) | (%) | (mg) | (%) |
| No | 11.69 | 7.93 | — | — | — | — | 10.03 | 14.21 | 7.70 | 2.86 |
| pretreatment | | | | | | | | | | |
| 100:100 | 11.31 | 8.15 | 1.01 | 91.09 | 7.40 | 9.13 | 0.88 | 92.18 | 6.86 | 15.82 |
| Acidic | | | | | | | | | | |
| 200:100 | 11.18 | 8.08 | 0.30 | 97.32 | 7.26 | 10.07 | 0.23 | 97.90 | 5.83 | 27.87 |
| Acidic | | | | | | | | | | |
| 100:100 | 11.35 | 8.02 | 2.19 | 80.70 | 7.68 | 4.24 | 1.89 | 83.32 | 7.24 | 9.70 |
| Neutral | | | | | | | | | | |

Example 2: EEM Analysis of CBZ Degradation Product

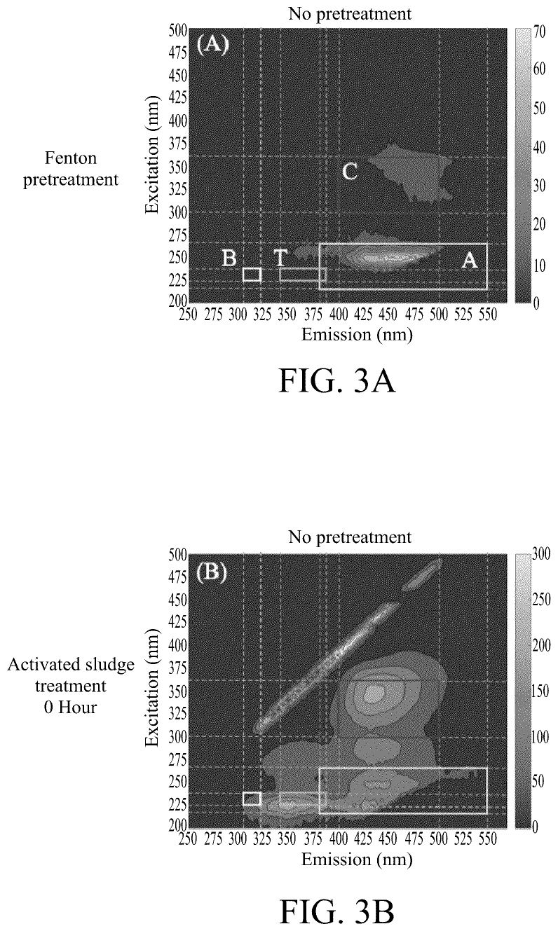

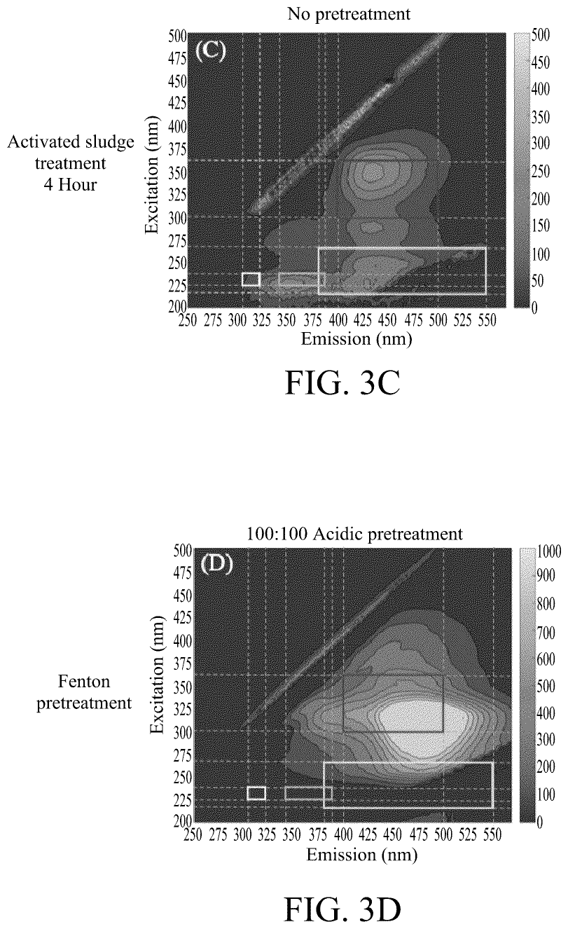

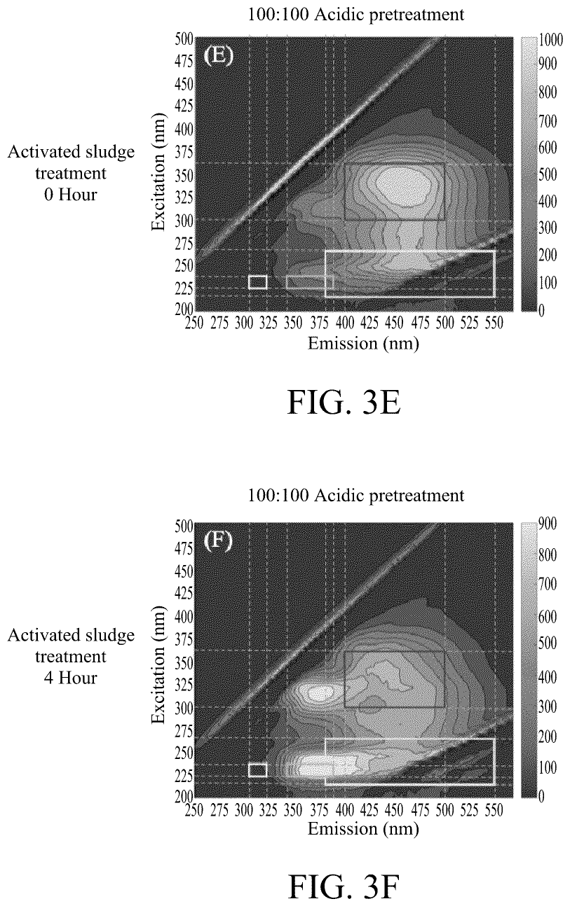

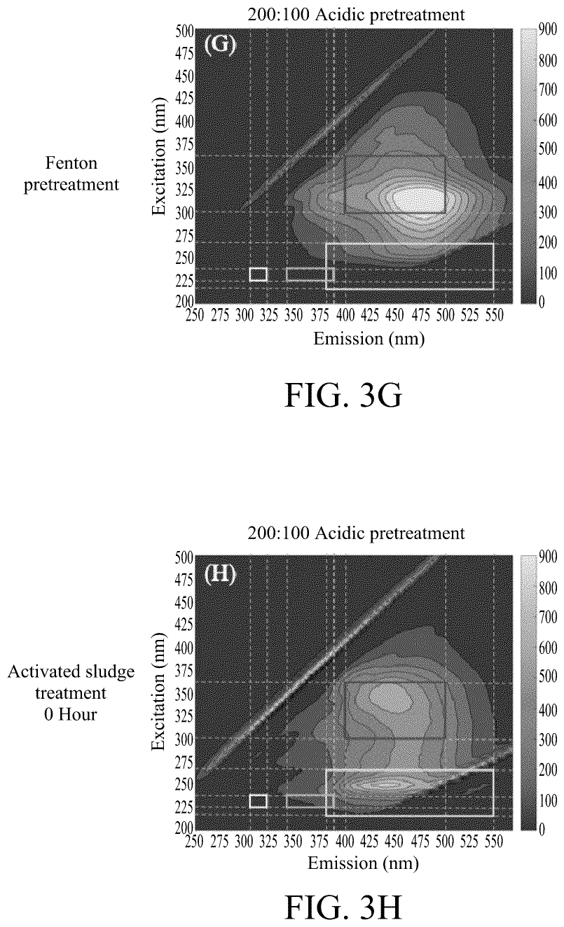

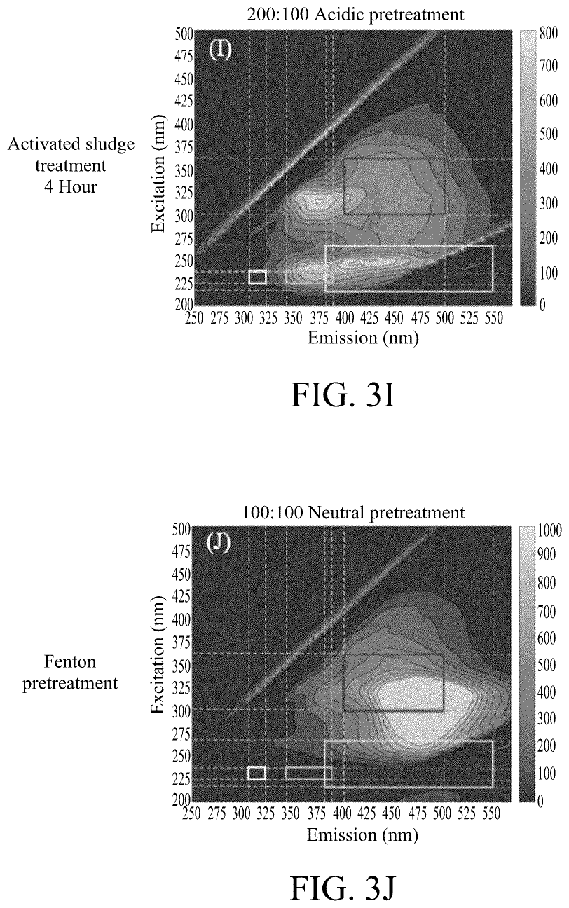

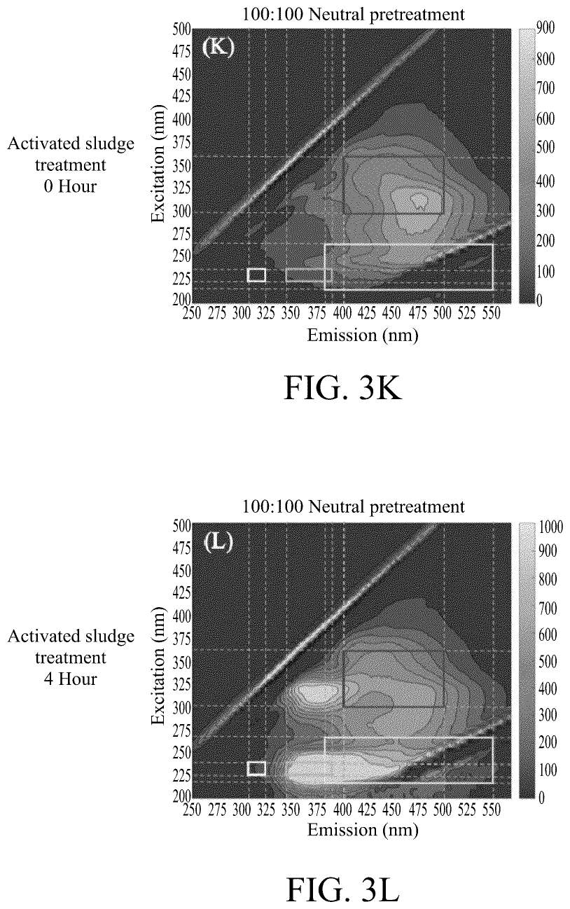

Samples were collected at the end of the Fenton oxidation pretreatment, at the beginning and end of the activated sludge treatment. Using excitation-emission matrix (EEM) fluorescence spectrometry, organics in wastewater are characterized. The EEMs under different pretreatment conditions were shown in FIGS. 3A-3L, and the common EEM features and the positions of fluorophores were illustrated in FIG. 3A. Peak A (yellow) represented fluvic acid-like compounds (FA-like) and occurred in the range of λₑₓ/λₑₘ=220-270 nm/380-550 nm. Peak C (red) represented humic acid-like compounds (HA-like) and occurred in the range of λₑₓ/λₑₘ=300-370 nm/400-500 nm. Peak B (white) represented Tyrosine-like compounds and occurred in the range of λₑₓ/λₑₘ=225-237 nm/309-321 nm. Peak T (pink) represented Tryptophan-like compounds and occurred in the range of λₑₓ/λₑₘ=225-237 nm/340-381 nm.

In FIGS. 3D, 3G and 3J, peak C signal appeared after the Fenton oxidation treatment, indicating the oxidation products contained HA-like structures, which are likely to be produced by hydroxyl radicals attacking and degrading CBZ. The pretreated solution was introduced into the activated sludge aeration tank for biological treatment, and the intensity of peak C decreased because of the dilution. Peaks A, B and T shown in FIGS. 3B, 3E, 3H and 3K were considered background values of the activated sludge. In Table 1, biodegradation efficiency was poor without the Fenton oxidation pretreatment, and similar results were also shown in FIGS. 3B and 3C. With the Fenton oxidation pretreatment, the biological removal of CBZ shifted the fluorescence signals toward shorter wavelength (see FIGS. 3F, 3I and 3L).

To be more specific, peaks A and C blue-shifted along the excitation and emission axes. The phenomenon of blue-shifted EEM signals may be associated with the following reasons: (i) the decomposition of aromatic moieties: (ii) the breakage of large molecules into smaller fragments: (iii) the decrease in aromatic ring quantity: (iv) the decrease in conjugated bonds in a chain structure: (v) the conversion from a linear structure into a non-linear structure: and (vi) the elimination of particular functional groups including carbonyl, hydroxyl and amine. The blue-shifted EEM results indicated that CBZ aromatic structure was decomposed and formed molecular fractions through the activated sludge treatment. Tyrosine- and tryptophan-like compounds (represented by peaks B and T) were reported to be small organics suitable for microbial activity and predominate in wastewater. The occurrence of peak T represented that organic compounds emerged after microbial oxidation of SBR treatment, and this confirmed the enhanced overall biodegradation of CBZ.

The wastewater treatment method of the present disclosure exhibits excellent CBZ removal ability. In comparison, Phan, Hop, et al. (“Bacterial Community Dynamics in an Anoxic-Aerobic Membrane Bioreactor-Impact on Nutrient and Trace Organic Contaminant Removal.” International Biodeterioration & Biodegradation, vol. 109, 2016, pp. 61-72) provided a method for CBZ treatment using an anoxic-aerobic membrane bioreactor (MBR: containing an activated sludge), but the removal rate was only 38.9±6.5% or 6.1±6.0% after activated sludge treatment (the sludge retention time >1000 d or =25 d). Similarly, according to Reif, R., et al.

“Fate of Pharmaceuticals and Cosmetic Ingredients during the Operation of a MBR Treating Sewage.” Desalination, vol. 221, no. 1-3, 2008, pp. 511-517, CBZ treatment using MBR containing activated sludge also only achieved a removal rate of 9%.

Although some specific Examples of the present disclosure have been illustrated above in detail, those skilled in the art can make various modifications and variations to the illustrated Examples without departing from the teachings and advantages of the present disclosure. Therefore, such modifications and variations should still be encompassed within the scope of the present disclosure as defined in the appended claims.

What is claimed is:

1. A method of wastewater treatment, comprising:
an advanced oxidation process that pretreats wastewater to oxidize organic pollutants within the wastewater; and
a biodegradation process that treats the pretreated wastewater to remove the oxidized organic pollutants,
wherein the organic pollutants are unsaturated compounds containing a strong electron-withdrawing functional group.

2. The method according to claim 1, wherein the advanced oxidation process is Fenton oxidation comprising oxidizing the organic pollutants with hydrogen peroxide as an oxidant under catalysis of ferrous ions; and wherein the biodegradation process is activated sludge treatment.

3. The method according to claim 2, wherein a molar ratio of the hydrogen peroxide to the ferrous ion is 0.5:1 to 50:1.

4. The method according to claim 2, wherein concentrations of the hydrogen peroxide and the ferrous ions are each independently 50 μM to 10000 μM.

5. The method according to claim 2, wherein the Fenton oxidation is carried out under a condition of an initial pH of the wastewater being 3 to 7.

6. The method according to claim 1, wherein the biodegradation process is carried out with a sequencing batch reactor, and each batch comprises four stages: inflow, aeration, sedimentation and outflow.

7. The method according to claim 1, wherein the unsaturated compounds containing a strong electron-withdrawing functional group are cyclic unsaturated compounds containing an amide: Ar—C(═O)—NR₁R₂, wherein Ar represents a substituted or unsubstituted aryl or heteroacyl, R₁ and R₂ are each independently hydrogen, a substituted or unsubstituted alkyl or alkyl containing a heteroatom.

8. The method according to claim 7, wherein the cyclic unsaturated compounds containing an amide comprise at least one selected from the group consisting of carbamazepine, N-substituted carbamazepine, oxcarbazepine, N-substituted oxcarbazepine, benzamide and N-substituted benzamide.

9. The method according to claim 1, wherein a degradation rate of the unsaturated compounds containing a strong electron-withdrawing functional group is 75% or above after treating the pretreated wastewater by the biodegradation process.

10. The method according to claim 1, wherein a mineralization rate of the unsaturated compounds containing a strong electron-withdrawing functional group is 8% or above after treating the pretreated wastewater by the biodegradation process.
